(19) United States
(12) Patent Application Publication
(10) Pub. No.: US 2020/0376705 A1
(43) Pub. Date: Dec. 3, 2020

(54) ELECTRIC CIRCULAR SAW

(71) Applicant: Nanjing Chervon Industry Co., Ltd., Nanjing (CN)

(72) Inventors: Masatoshi Fukinuki, Nanjing (CN); Songsong Lu, Nanjing (CN); Hongbin Wang, Nanjing (CN)

(21) Appl. No.: 16/994,850

(22) Filed: Aug. 17, 2020

Related U.S. Application Data
(63) Continuation of application No. PCT/CN2018/080079, filed on Mar. 22, 2018.

(30) Foreign Application Priority Data
Mar. 9, 2018 (CN) 201820332122.4

(51) Int. Cl. B27B 9/00; B25F 5/00; B23D 45/16; B23D 47/12

(52) U.S. Cl. CPC B27B 9/00; B23D 47/12; B23D 45/16; B25F 5/008

(57) ABSTRACT

An electric circular saw includes a saw blade, a motor, a housing, a bottom plate, a worm gear assembly and a power supply device. The saw blade is configured to rotate about a first axis. The motor has a motor shaft for driving the saw blade to rotate. The housing has an accommodating portion for accommodating the motor. The worm gear assembly realizes power transmission between the motor and the saw blade. The power supply device includes at least one battery pack to power the motor. The ratio of the nominal voltage of one battery pack to the weight of the electric circular saw is greater than or equal to 6 V/Kg and less than or equal to 12 V/Kg.

### RELATED APPLICATION INFORMATION

This application is a continuation of International Application Number PCT/CN2018/080079, filed on Mar. 22, 2018, through which this application also claims the benefit under 35 U.S.C. § 119(a) of Chinese Patent Application No. CN 201820332122.4, filed on Mar. 9, 2018, which applications are incorporated by reference in their entirety herein.

### TECHNICAL FIELD

The invention relates to a power tool, in particular to an electric circular saw.

### BACKGROUND

Electric circular saws are commonly used to cut wood, plastic, etc. In existing electric circular saws, generally, the axis of rotation of the saw blade is parallel to the axis of the motor, and a planetary gear reduction mechanism is provided between the saw blade and the motor, but these settings will lower the efficiency of the electric circular saw. Moreover, existing DC electric circular saws generally have a low rated input power, and the nominal voltage of the battery pack may not meet the requirements of high power, long working time, and strong load capacity.

### SUMMARY

In one aspect of the disclosure, an electric circular saw, comprising: a saw blade configured to rotate about a first axis; a motor comprising a motor shaft for driving the saw blade to rotate; a housing provided with an accommodating portion for accommodating the motor; a bottom plate provided with a bottom plate plane for contacting a workpiece; a worm gear assembly for realizing power transmission between the motor and the saw blade; and a power supply device comprising at least one battery pack for providing energy source to the motor; wherein a ratio of a nominal voltage of one of the at least one battery pack battery pack to a weight of the electric circular saw is greater than or equal to 6V/Kg and less than or equal to 12V/Kg; wherein the housing comprises: a main handle comprising a first grip portion for a user to grip; and a coupling portion for detachably coupling with the at least one battery pack, wherein the coupling portion connects the main handle and the accommodating portion; and wherein the main handle, the accommodating portion, and the coupling portion are sequentially connected to form an opening through which the user's hand holding the first grip portion passes.

In a further example, the housing further comprises: an auxiliary handle comprising a second grip portion for the user to hold; and wherein the first grip portion is symmetrically disposed about a plane, the second grip portion extends in a direction obliquely intersecting the plane, and the direction in which the second grip portion extends obliquely intersects the plane to form an included angle greater than or equal to 50 degrees and less than or equal to 70 degrees.

In a further example, the power supply device comprises a plurality of battery cells, and a ratio of a diameter of the saw blade to a number of the battery cells comprised in the power supply device is greater than or equal to 6 mm/node and less than or equal to 11 mm/node.

In a further example, a number of the at least one battery pack is 1, an motor axis of rotation of the motor shaft relative to the housing is perpendicular to the first axis, and the at least one battery pack is disposed between the main handle and the motor.

In a further example, a number of the at least one battery pack is 2, the at least one battery pack are respectively defined as a first battery pack and a second battery pack, the coupling portion is defined as a first coupling portion, the housing is further provided with a second coupling portion for detachably coupling with the second battery pack, and the first coupling portion is provided between the motor and the second coupling portion in a direction of an axis of rotation of the motor shaft.

In a further example, a direction in which the first battery pack couples to the first coupling portion and a direction in which the second battery pack couples to the second coupling portion are perpendicular to each other.

In a further example, the bottom plate plane extends in a first plane; when the bottom plate plane and the first axis are parallel to each other, a projection of the at least one battery pack in the first plane is outside a projection of the bottom plate in the first plane.

In a further example, one of the at least one battery pack comprises: a plurality of battery cells; and a battery pack case encircling a battery compartment for accommodating the battery cells; wherein the battery pack case is provided with a groove into which the coupling portion is embedded when the at least one battery pack couples to the battery pack case.

In a further example, the nominal voltage of the at least one battery pack is 48V.

In a further example, one of the at least one battery pack comprises a plurality of battery cell groups connected in series, and each battery cell group comprises two battery cells connected in parallel with each other.

In a further example, the main handle being disposed symmetrically about a plane, and a rotation axis of the motor shaft rotates relative to the housing being located in the plane.

In a further example, when the at least one battery pack couples to the housing, the at least one battery pack is also disposed symmetrically about the plane.

In a further example, further comprises a circuit board disposed in the accommodating portion, the circuit board and the motor forming an electrical connection; wherein the housing is provided with an airflow inlet and an airflow outlet, and a cooling airflow that flows into the housing from the airflow inlet and flows out of the housing from the airflow outlet sequentially flows through the circuit board and the motor.

In a further example, the circuit board comprises a PCB substrate that extends in a plane perpendicular to an axis of rotation about which the motor shaft rotates relative to the housing.

In a further example, further comprises a heat sink connected to the circuit board, the heat sink comprising a cooling substrate extending in the second plane; wherein the second plane is perpendicular to the axis of rotation about which the motor shaft rotates relative to the housing.

In a further example, the heat sink also comprises: a sidewall surrounding the cooling substrate at the edge of the cooling substrate; and a plurality of cooling ribs provided on the sidewall; wherein the plurality of cooling ribs extend in a direction parallel to the axis of rotation about which the motor shaft rotates relative to the housing.

In a further example, the heat sink also comprises: a sidewall surrounding the cooling substrate at the edge of the cooling substrate; a plurality of cooling ribs provided on the sidewall; and an airflow channel for guiding the airflow provided between two adjacent cooling ribs; wherein the electric circular saw further comprises a wire for connecting the circuit board and the motor; the wire passes through the airflow channel between the two cooling ribs.

In a further example, the accommodating portion is made of metal material.

In a further example, further comprises: a circuit board provided in the accommodating portion; a wire connecting the circuit board and the motor; and a limit baffle surrounding a partially open limit space; wherein the limit baffle restricts the wire within the limit space to prevent the wire from contacting the accommodating portion.

In another aspect of the disclosure, an electric circular saw, comprising: a saw blade configured to rotate about a first axis; a motor comprising a motor shaft for driving the saw blade to rotate; a housing provided with an accommodating portion for accommodating the motor; a bottom plate provided with a bottom plate plane for contacting a workpiece; a worm gear assembly for realizing power transmission between the motor and the saw blade; and a power supply device comprising at least one battery pack for providing energy source to the motor; wherein a ratio of a nominal voltage of one of the at least one battery pack battery pack to a weight of the electric circular saw is greater than or equal to 6V/Kg and less than or equal to 12V/Kg; wherein the housing comprises: a main handle comprising a first grip portion for a user to grip with one hand; an auxiliary handle comprising a second grip portion for the user to hold with the other hand; and a coupling portion for detachably coupling with the at least one battery pack; and wherein a center of gravity of the electric circular saw is located between the first grip portion and the second grip portion.

### BRIEF DESCRIPTION OF THE DRAWINGS

FIG. 1 is a perspective view of an electric circular saw according to a first example of the invention;

FIG. 2 is a perspective view of the electric circular saw in FIG. 1 from another angle;

FIG. 3 is a plan view of the electric circular saw in FIG. 1;

FIG. 4 is a rear view of the electric circular saw in FIG. 1;

FIG. 5 is a top view of the electric circular saw in FIG. 1;

FIG. 6 is a perspective view of the electric circular saw in FIG. 1 when the battery pack is detached;

FIG. 7 is a perspective view of the electric circular saw in FIG. 1 when the housing is partially removed;

FIG. 8 is a perspective view of the electric circular saw in FIG. 1 when the housing and the limit baffle are partially removed;

FIG. 9 is another perspective view of the structure shown in FIG. 8;

FIG. 10 is a perspective view of the battery pack in FIG. 1 when the battery pack case is partially separated;

FIG. 11 is a perspective view of the circuit board and heat sink in FIG. 10;

FIG. 12 is a perspective view of an electric circular saw according to a second example;

FIG. 13 is a rear view of the electric circular saw in FIG. 12;

FIG. 14 is a perspective view of the electric circular saw in FIG. 12 when the battery pack is detached;

FIG. 15 is a perspective view of an electric circular saw according to a third example;

FIG. 16 is a rear view of the electric circular saw in FIG. 15;

FIG. 17 is a perspective view of the electric circular saw in FIG. 15 when the battery pack is detached.

### DETAILED DESCRIPTION

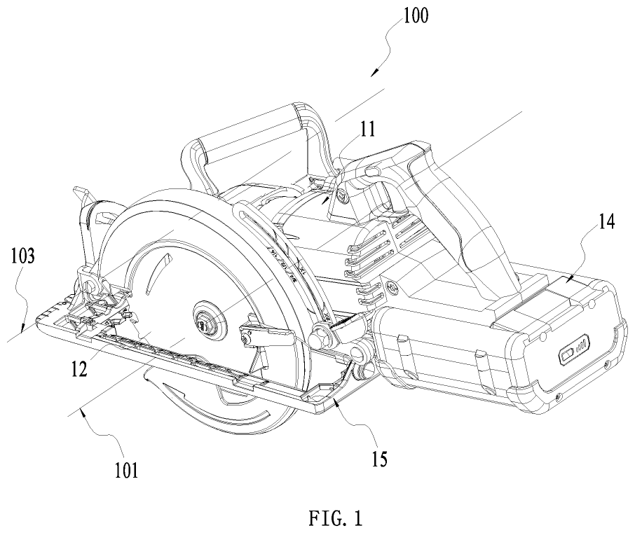

An electric circular saw 100 of a first example as shown in FIG. 1 is used by a user to cut a workpiece, for example, for the user to cut wood, plastic, stone, etc.

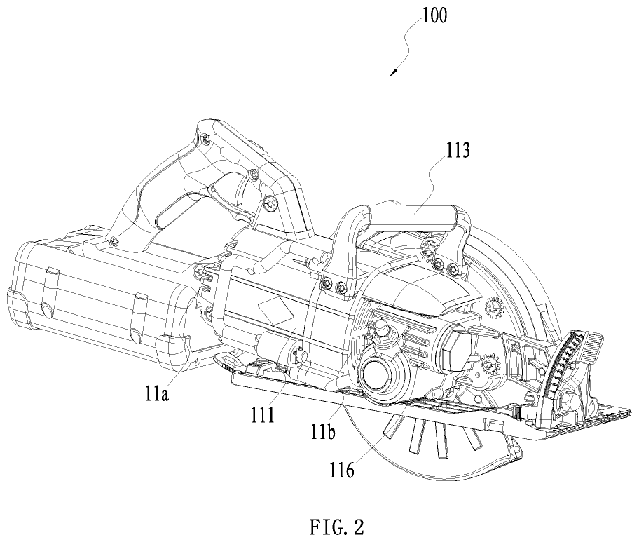

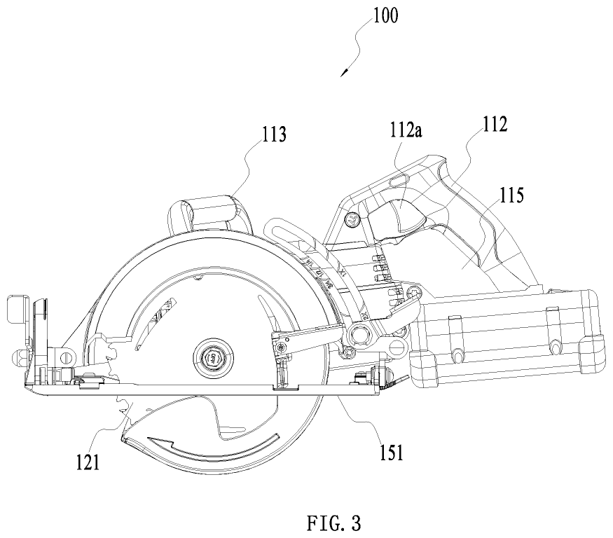

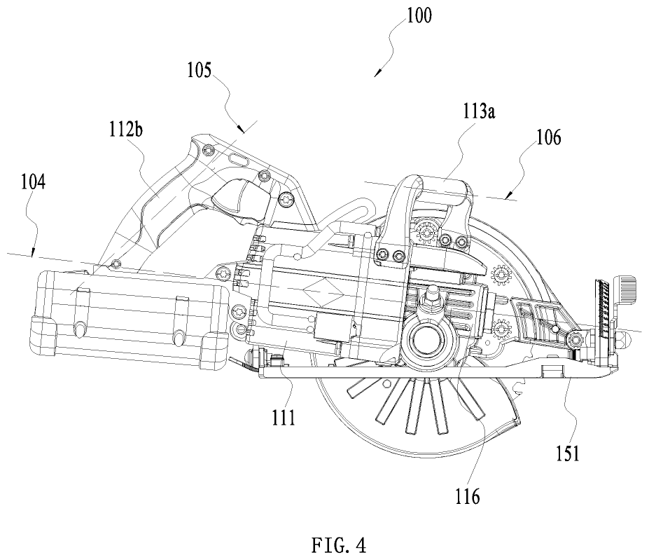

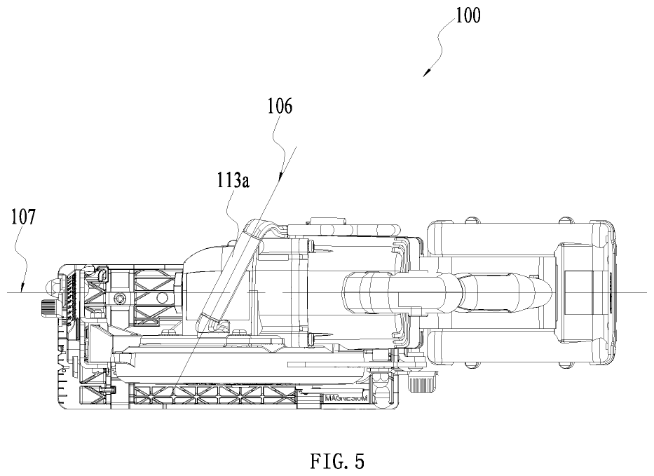

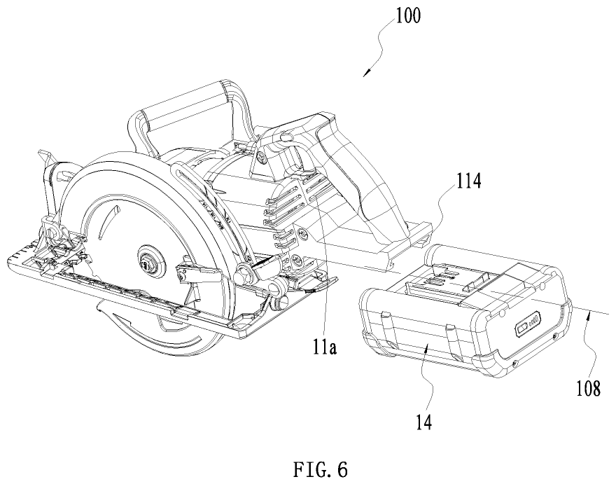

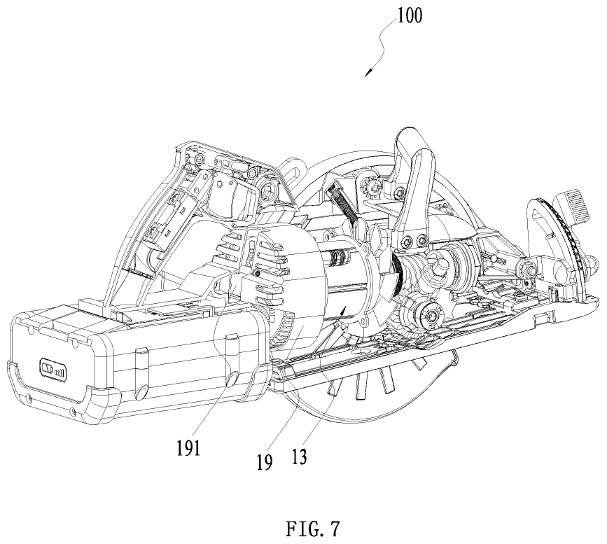

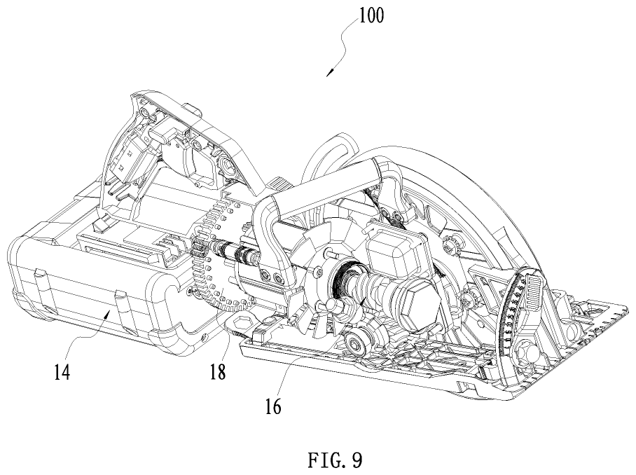

As shown in FIGS. 1 to 9, the electric circular saw 100 includes: a housing 11, a saw blade 12, a motor 13, a power supply device, and a bottom plate 15, wherein the power supply device includes a battery pack 14 for providing energy source for the electric circular saw 100. In this example, the number of battery packs 14 is one, and the saw blade 12 is a circular saw blade 12 that rotates about a first axis 101.

The housing 11 includes an accommodating portion 111 for accommodating the motor 13, and the accommodating portion 111 is provided with an inner cavity for placing the motor 13. The housing 11 is also provided with a main handle 112 and an auxiliary handle 113. The accommodating portion 111 is located on one side of the saw blade 12. The main handle 112 is for the user to grip and control the electric circular saw 100 with one hand, and the main handle 112 is also provided with an operation switch 112a for controlling the start and stop of the electric circular saw 100. The auxiliary handle 113 is for the user to grip with the other hand. The saw blade 12 cuts a workpiece while rotating about the first axis 101 relative to the housing 11. The motor 13 includes a motor shaft 131 that can rotate about a motor axis 102. The motor axis 102 is perpendicular to the first axis 101. The battery pack 14 can be detachably coupled to the housing 11 by the user to supply power to the motor 13. The bottom plate 15 includes a bottom plate plane 151 for contacting the workpiece, and the bottom plate plane 151 extends in a first plane. The bottom plate 15 also forms a rotational connection with the housing 11 about a second axis 103. The second axis 103 is also parallel to the first axis 101 about which the saw blade 12 rotates. In this way, when the bottom plate 15 rotates about the second axis 103 relative to the housing 11, the size of a cutting portion 121 protruding to the lower side of the bottom plate plane 151 of the saw blade 12 changes accordingly in order to adjust the cut size of the workpiece.

Specifically, the accommodating portion 111 extends substantially in a direction of a first straight line 104 which is perpendicular to the first axis 101 about which the saw blade 12 rotates. In this way, the motor 13 may also be arranged in the inner cavity surrounded by the accommodating portion 111 substantially along the direction of the first straight line 104, so that the motor axis 102 and the first straight line 104 may be substantially parallel to or coincide with each other. When the bottom plate plane 151 and the first axis 101 are parallel to each other and have the shortest distance from the first axis 101, the first straight line 104 also obliquely intersects with the bottom plate plane 151 to form an included angle greater than 0 degrees and less than or equal to 20 degrees. In order to make the motor 13 drive the saw blade 12 to rotate about the first axis 101, the electric circular saw 100 further includes a worm gear assembly 16 that realizes power transmission between the motor 13 and the saw blade 12.

The main handle 112 includes a first grip portion 112b to be gripped by the user. The first grip portion 112b extends substantially along a first direction 105. The auxiliary handle 113 includes a second grip portion 113a to be gripped by the user. The second grip portion 113a extends substantially along a second direction 106. Wherein, the main handle 112 is also symmetrically arranged about a symmetry plane 107 which is perpendicular to the first axis 101. When the bottom plate plane 151 and the first axis 101 are parallel to each other and the distance between the bottom plate plane 151 and the first axis 101 is closest, the symmetry plane 107 of the main handle 112 is also perpendicular to the bottom plate plane 151. The first direction 105 in which the first grip extends and the bottom plane 151 obliquely intersect to form an included angle greater than or equal to 30 degrees and less than or equal to 60 degrees. At this time, the second direction 106 in which the second grip portion 113a extends is parallel to the bottom plate plane 151 or intersects with the bottom plate plane 151 to form an included angle greater than 0 degrees and less than 20 degrees, and the second direction 106 in which the second grip portion 113a extends also intersects with the symmetry plane 107 to form an included angle greater than or equal to 50 degrees and less than or equal to 70 degrees, so that when the user holds the first grip portion 112b and the second grip portion 113a with both hands, the directions of the arms of the two hands intersect, thereby making the arrangement of the main handle 112 and the auxiliary handle 113 more ergonomic.

The casing 11 is also provided with a coupling portion 114 for detachably coupling the battery pack 14. The coupling portion 114 is provided at one end of the main handle 112. The main handle 112 connects the coupling portion 114 and the accommodating portion 111. The coupling portion 114 is also connected to the main handle 112 and the accommodating portion 111, so that the main handle 112, the accommodating portion 111, and the coupling portion 114 are sequentially connected and encircle an opening 115 through which the user's hand holding the first grip portion 112b passes, and the opening 115 is located on the side of the motor 13 away from the worm gear assembly 16, that is, the motor 13 is disposed between the opening 115 and the worm gear assembly 16. The battery pack 14 is inserted into the coupling portion 114 along a direction of a second straight line 108, which may be parallel or coincident with the motor axis 102, and the second straight line 108 is also perpendicular to the first axis 101 about which the saw blade 12 rotates. In this example, when the battery pack 14 is inserted into the coupling portion 114, when the bottom plate plane 151 and the first axis 101 are parallel to each other, battery pack 14 in the first plane is outside the projection of the bottom plate 15 in the first plane, in this way, in a direction perpendicular to the first axis 101 and parallel to the bottom plate plane 151, the center of gravity of the entire electric circular saw 100 moves backward, so that in the direction perpendicular to the first axis 101, the center of gravity of the electric circular saw 100 can be located between the first grip portion 112b and the second grip portion 113a, thereby improving the balance performance of the entire machine.

When the bottom plate plane 151 and the first axis 101 are parallel to each other and the distance between the bottom plate plane 151 and the first axis 101 is the smallest, the projection of the first grip portion 112b in the first plane is outside the projection of the bottom plate 15 in the first plane, the projection of the second grip portion 113a in the first plane is inside the projection of the bottom plate 15 in the first plane, such that the distance between the first grip portion 112b and the second grip portion 113a can be made large enough to allow the user to manipulate the electric circular saw 100 more stably when the user holds the first grip portion 112b and the second grip portion 113a with both hands.

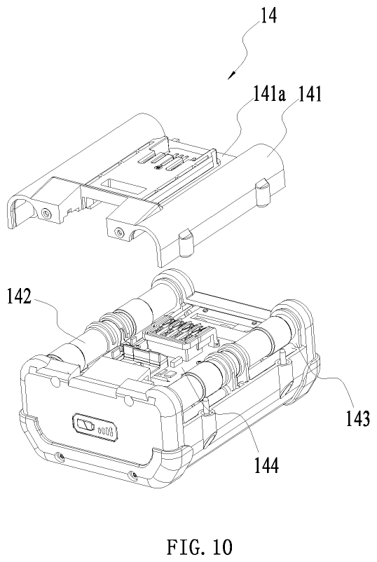

As shown in FIG. 1 and FIG. 10, the battery pack 14 includes a battery pack case 141 and a plurality of battery cells 142, wherein the battery pack case 141 encircles a battery compartment 143 to accommodate the battery cells 142, and the number of the battery cells 142 is multiple. In this example, the rated input power of the electric circular saw 100 is greater than or equal to 1.3 KW and less than or equal to 1.7 KW. Further, the rated input power of the electric circular saw 100 is 1.5 KW. The diameter of the saw blade 12 is greater than or equal to 0.15 m and less than or equal to 0.21 m. Further, the diameter of the saw blade 12 is 0.185 m. Therefore, in order to avoid excessive size and weight of the electric circular saw 100, and to meet the capacity requirements of the battery pack 14 in the power supply device, the ratio of the nominal voltage of the battery pack 14 to the weight of the electric circular saw 100 is greater than or equal to 6V/Kg and less than or equal to 12V/Kg. Further, the ratio of the nominal voltage of the battery pack 14 to the weight of the electric circular saw 100 is greater than or equal to 7.5V/Kg and less than or equal to 9V/Kg. In this way, the nominal voltage of the battery pack 14 could be set within a reasonable range to meet the requirements of the rated operating conditions of the whole machine. Setting the rated capacity of the battery pack 14 based on the nominal voltage can reduce the size of the entire electric circular saw 100 and the weight of the electric circular saw 100 as much as possible while the rated capacity allows the discharge time of the battery pack 14 to satisfy user needs. Therefore, the ratio of the nominal voltage of the battery pack 14 to the weight of the electric circular saw 100 in the present invention is a parameter that comprehensively balances the load capacity, working time, size, and weight of the electric circular saw 100.

Further, in order to meet the working time of the electric circular saw 100 under rated operating conditions, the ratio of the diameter of the saw blade 12 in the present invention to the number of the battery cells 142 included in the power supply device is greater than or equal to 6 mm/cell and less than or equal to 11 mm/cell, further, the ratio of the diameter of the saw blade 12 to the number of the battery cells 142 included in the power supply device is greater than or equal to 6 mm/cell and less than or equal to 8.5 mm/cell, thereby making the electric circular saw 100 meet the requirements of operating conditions when the discharge time of the power supply device also meet user needs. More specifically, in this example, the number of battery packs 14 is 1, the nominal voltage of the battery pack 14 is set to 48V, the battery cells 142 are lithium-ion cells. When the rated voltage of a battery cell 142 is 4V, the battery pack 14 must include at least 12 battery cells 142. In order to make the rated capacity of the battery pack 14 meet the requirements of the discharge time, all the battery cells 142 in the battery pack 14 constitute a plurality of battery cell 142 groups connected in series, each battery cell 142 group includes two of the above-mentioned battery cells 142, that is to say, every two battery cells 142 in the battery pack 14 are connected in parallel to form a battery cell 142 group, and a plurality of battery cell 142 groups are connected in series, wherein the number of battery cells 142 is 12, so that the size of the electric circular saw 100 will not be too large and the weight will not be too heavy when the battery pack 14 meets the requirements of the rated capacity.

As shown in FIG. 10, there is a gap 144 between two of the battery cells 142 of the battery pack 14, so that the battery pack case 141 can sink into the gap 144 to form a groove 141a. In this way, when the battery pack 14 is mounted to the coupling portion 114, the coupling portion 114 can be located in the groove 141a. The concave direction of the groove 141a is substantially perpendicular to the bottom plate plane 151, or the concave direction of the groove 141a and the bottom plate plane 151 intersect to form an included angle greater than or equal to 70 degrees and less than or equal to 90 degrees, so that when the electric circular saw 100 performs the cutting operation, the bottom plate surface 151 is in contact with the workpiece, whereas the battery pack 14 does not touch the workpiece, so that the balance performance of the whole machine is not affected, which facilitates user operation, and enables the user to insert and remove the battery pack 14 smoothly. When the battery pack 14 is coupled to the coupling portion 114, the battery pack 14 is also symmetrically arranged about the plane 107, so that the center of gravity of the electric circular saw 100 is close to the plane 107 of the main handle 112, thereby improving the balance performance of the whole machine. When the bottom plate plane 151 and the first axis 101 are parallel to each other and the distance between the bottom plate plane 151 and the first axis 101 is the smallest, the direction along the second straight line 108 in which the battery pack 14 is mounted to the coupling portion 114 also intersects with the bottom plate plane 151 obliquely to form an included angle greater than 0 degrees and less than or equal to 20 degrees, which is convenient for users to insert and remove the battery pack 14.

In the direction along the first straight line 104, the motor 13 is disposed between the battery pack 14 and the worm gear assembly 16. The battery pack 14, the motor 13, and the worm gear assembly 16 are substantially sequentially disposed along the first straight line 104. The motor axis 102 is located in the plane where the plane 107 is located, and the motor 13 is also symmetrically arranged about the plane 107, so that the center of gravity of the electric circular saw 100 can be further placed close to the plane 107, thereby improving the balance performance of the electric circular saw 100.

In order to dissipate heat from the motor 13, the housing 11 is further provided with an airflow inlet 11a and an airflow outlet 11b, wherein the airflow inlet 11a is provided at an end of the accommodating portion 111 close to the opening 115 in the direction of the first straight line 104, and the airflow inlet 11a is opened toward the opening 115. Since the battery pack 14 is provided at the coupling portion 114 between the main handle 112 and the accommodating portion 111, when a cooling airflow from the airflow inlet 11a into the interior of the housing 11 is generated, the cooling airflow outside the housing 11 can also partially flow through the battery pack 14 so as to have a certain cooling effect on the battery pack 14, and the airflow inlet 11a is also located between the battery pack 14 and the motor 13. The airflow outlet 11b is provided on the accommodating portion 111, and the airflow outlet 11b is also located at the end of the motor 13 near the worm gear assembly 16, so that the cooling airflow from the airflow inlet 11a to the airflow outlet 11b can flow through the motor 13 to effectively cool the motor 13. The housing 11 is also provided with a box 116 for accommodating the worm gear. The box 116 is concaved in a radial direction perpendicular to the motor axis 102 relative to the accommodating portion 111, so that the cooling airflow from the airflow outlet 11b can flow through the exterior of the box 116 to cool the worm gear assembly 16 located inside the casing 116. In this example, the box 116 and the accommodating portion 111 are integrally formed, and the interior of the box 116 and the interior of the accommodating portion 111 are connected to each other. In this way, part of the cooling airflow will flow through the interior of the box 116 and then flows out from the saw blade 12 to further cool the worm gear assembly 16.

In order to control the motor 13 and the battery pack 14, the electric circular saw 100 further includes a circuit board 17. The circuit board 17 is electrically connected to the motor 13 through a wire 171. The circuit board 17 is located in the accommodating portion 111, and the circuit board 17 is also disposed between the motor 13 and the airflow inlet 11a, so that the cooling airflow can sequentially pass through the circuit board 17 and the motor 13, and the cooling airflow can also cool the circuit board 17. In this example, the circuit board 17 includes a PCB substrate 172 extending in a plane perpendicular to the motor axis 102. In order to match the shape of the accommodating portion 111, the PCB substrate 172 is substantially circular, so that the space occupied by the circuit board 17 in the accommodating portion 111 is reduced, which makes the internal arrangement of the accommodating portion 111 more compact.

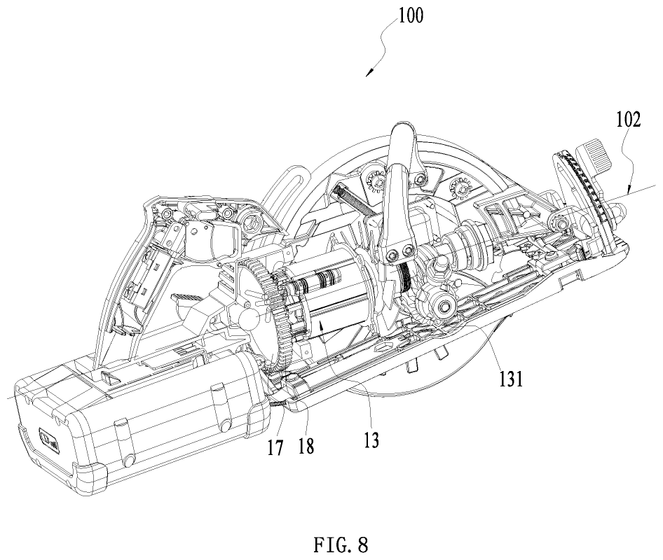

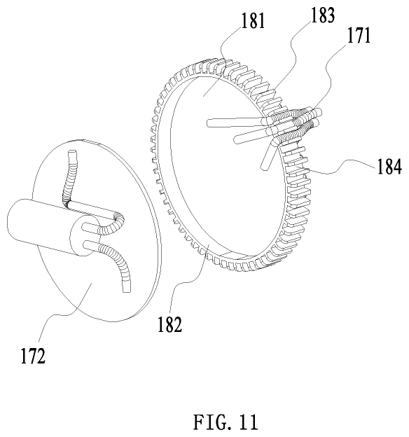

As shown in FIG. 8 and FIG. 11, the electric circular saw 100 further includes a heat sink 18 which can further cool the circuit board 17. The heat sink 18 is provided in the accommodating portion 111, and the heat sink 18 is further provided between the airflow inlet 11a and the motor 13. The heat sink 18 includes a cooling substrate 181 extending in a second plane perpendicular to the motor axis 102. The shape of the cooling substrate 181 may be substantially the same as that of the PCB substrate 172. For example, in this example, the cooling substrate 181 is also circular. The heat sink 18 further includes a sidewall 182 surrounding the cooling substrate 181 along the edge of the circular cooling substrate 181, and the sidewall 182 also extends in a cylindrical surface around the motor axis 102. Thus, the cooling substrate 181 and the sidewall 182 encircle a receiving space for mounting the circuit board 17. The side wall 182 is formed with a plurality of cooling ribs 183 arranged at intervals. The cooling ribs 183 extend in a direction parallel to the motor axis 102. An airflow channel 184 for guiding the cooling airflow extending in a direction parallel to the motor axis 102 is also formed between two adjacent cooling ribs 183, and the airflow channel 184 also extends in a direction parallel to the motor axis 102. The wire 171 connecting the circuit board 17 and the motor 13 can also be arranged in the airflow channel 184 formed between two adjacent cooling ribs 183, and the wire 171 passes through the airflow channel 184, so that the wire 171 can not only be cooled, but also be fixed, and the inner structure of the accommodating portion 111 can be arranged more compactly.

In this example, the accommodating portion 111 and the box 116 of the housing 11 are made of metal materials, such that the hardness of the housing 11 meets the requirements. Further, the accommodating portion 111 and the box 116 can be made of aluminium alloy materials, such that the weight of the housing 11 is reduced. The electric circular saw 100 also includes a limit baffle 19; the limit baffle 19 encircles a limit space 191. The limit baffle 19 limits the wire 171 in the limit space 191 to prevent the wire 171 from contacting the wall of the accommodating portion 111. The limit baffle 19 is made of insulating materials. In this way, the wire 171 is restrained in the limit space 191, so that the wire 171 will not contact the wall of the accommodating portion 111, thereby ensuring that the creepage distance between the circuit board 17 and the housing 11 meets the requirements of safety regulations, and also ensures that the creepage distance between the wire 171 and the housing 11 meets the requirements of safety regulations. The limit space 191 opens towards the motor 13, and the limit space 191 also opens towards the airflow inlet 11a, so that the cooling airflow can flow through the limit space 191 encircled by the limit baffle 19.

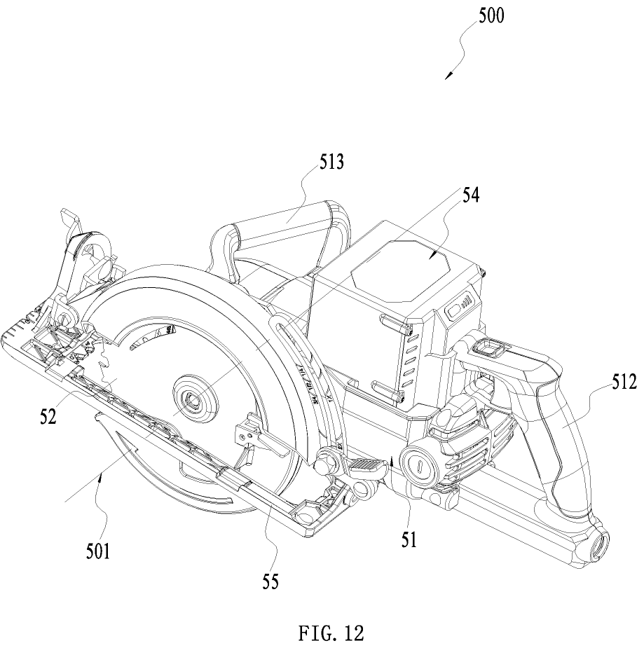

FIG. 12 shows the structure of an electric circular saw 500 of a second example. In this example, the electric circular saw 500 includes a saw blade 52, a motor, and a bottom plate 55 with the same structure as in the first example. The only difference lies in a power supply device including a battery pack 54 having a different structure and a different position from those of the first example. At the same time, the electric circular saw 500 also includes a housing 51 that matches the structure of the battery pack 54. The electric circular saw 500 may have the same rated input power as the first example, and the battery pack 54 may have the same nominal voltage, the same number of battery cells, and the same rated capacity as the first example. The housing 51 may have the same main handle 512, auxiliary handle 513, and accommodating portion 511 as in the first example. The parts of the first example that are compatible with this example can all be applied to this example. The following mainly introduces the differences between this example and the first example.

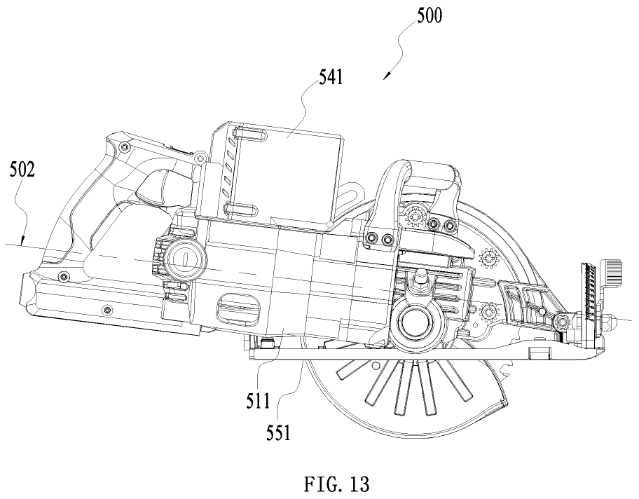

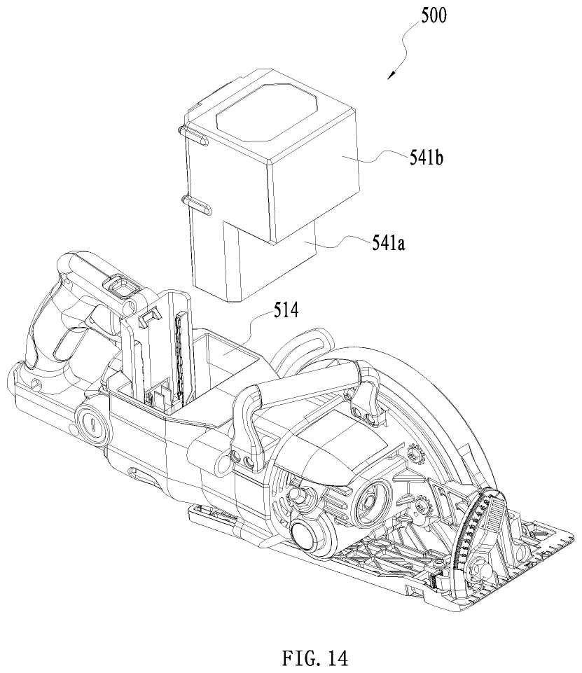

As shown in FIGS. 12-14, in this example, in the direction along the motor axis 502, the battery pack 54 is disposed between the main handle 512 and the motor. The housing 51 is recessed and formed with a receiving groove 514 between the main handle 512 and the accommodating portion 511. The receiving groove 514 opens towards the outside. The battery pack 54 may be detachably coupled to the receiving groove 514 along a straight line direction. The direction in which the battery pack 54 is coupled to the receiving groove 514 and a first axis 501 about which the saw blade 52 rotates are perpendicular to each other. When a bottom plate plane 551 and the first axis 501 are parallel to each other and the distance between the bottom plate plane 551 and the first axis 501 is the smallest, the direction in which the battery pack 54 is coupled to the receiving groove 514 intersects with the bottom plate plane 551 to form an included angle greater than or equal to 70 degrees and less than or equal to 90 degrees.

In the direction along the motor axis 502, the receiving groove 514 is provided between the main handle 512 and the motor. For the battery pack 54 with a nominal voltage of 48V, an L-shaped battery pack case 541 is presented in this example to refrain the dimension of the entire electric circular saw 500 along the motor axis 502 from being too large when the battery pack 54 is inserted into the receiving groove 514. Specifically, the battery pack case 541 includes a first accommodating portion 541a and a second accommodating portion 541b, and the first accommodating portion 541a and the second accommodating portion 541b are perpendicular to each other. The battery cells in the battery pack 54 could be divided into two types, battery cells of a first type are at least partially disposed in the first accommodating portion 541a and battery cells of a second type are at least partially disposed in the second accommodating portion 541b. In this way, when the battery pack 54 is inserted into the receiving groove 514, the first accommodating portion 541a is located inside the receiving groove 514, whereas the second accommodating portion 541b is located outside the receiving groove 514. And at this time, the size of the first accommodating portion 541a in the direction along the motor axis 502 is smaller than the size of the second accommodating portion 541b in the direction along the motor axis 502, so that the size of the electric circular saw 500 along the motor axis 502 can be reduced, thereby making the overall layout of the entire electric circular saw 500 more compact, helping the miniaturization of the electric circular saw 500.

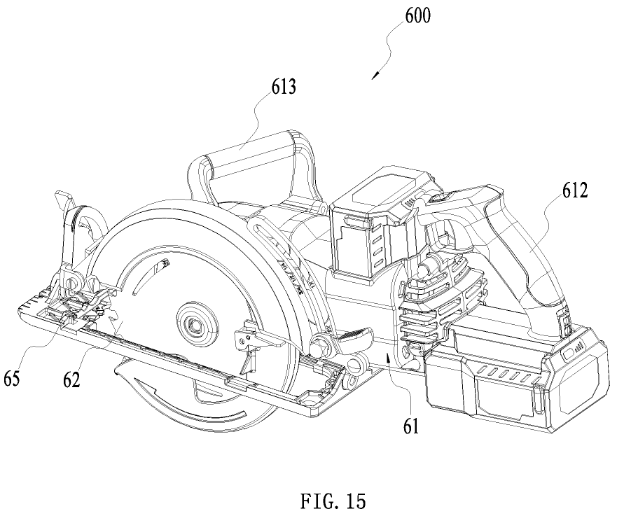

FIG. 15 shows the structure of an electric circular saw 600 of a third example. In this example, the electric circular saw 600 includes a saw blade 62, a motor, and a bottom plate 65 with the same structure as in the first example. The only difference lies in a power supply device including two battery packs having a different structure and a different position from those of the first example, namely a first battery pack 641 and a second battery pack 642. At the same time, the electric circular saw 600 also includes a housing 61 that matches the structure of the first battery pack 641 and the second battery pack 642. The electric circular saw 600 may have the same rated input power as the first example, the first battery pack 641 may have the same nominal voltage as the first example, and the second battery pack 642 may also have the same nominal voltage as the first example. The sum of the number of battery cells contained in the first battery pack 641 and the number of battery cells contained in the second battery pack 642 is the same as the number of battery cells contained in the battery pack in the first example. The sum of the rated capacity of the first battery pack 641 and the rated capacity of the second battery pack 642 is the same as the rated capacity of the battery pack in the first example. The housing 61 may have the same main handle 612, auxiliary handle 613, and accommodating portion 611 as the first example. The parts of the first example that are compatible with this example can all be applied to this example. The following mainly introduces the differences between this example and the first example.

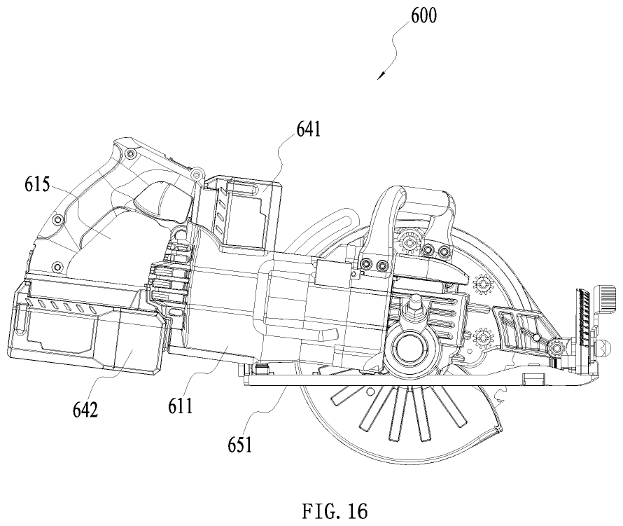

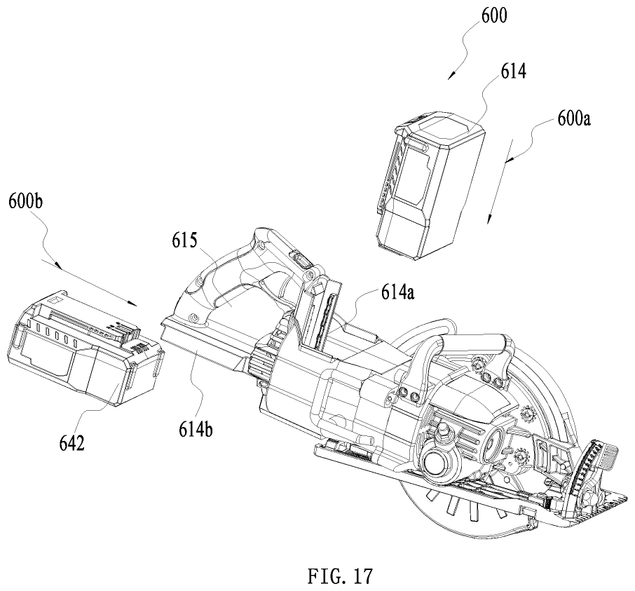

As shown in FIGS. 15-17, in this example, the housing 61 is provided with a first coupling portion 614a and a second coupling portion 614b for coupling the first battery pack 641 and the second battery pack 642, respectively. In the direction of the motor axis, the first coupling portion 614a is disposed between the second coupling portion 614b and the motor, and the first coupling portion 614a is also disposed between the main handle 612 and the accommodating portion 611. When the first battery pack 641 is coupled to the first coupling portion 614a and the second battery pack 642 is coupled to the second coupling portion 614b, the first battery pack 641 is disposed between the second battery pack 642 and the motor in the direction along the motor axis.

Specifically, the first coupling portion 614a is the housing 61 with a receiving groove recessed between the main handle 612 and the accommodating portion 611; the receiving groove opens outwards, and the first battery pack 641 is inserted into the receiving groove along a first direction 600a. The first direction 600a is also perpendicular to a first axis about which the saw blade 62 rotates. The second coupling portion 614b connects the main handle 612 and the accommodating portion 611, and the main handle 612 also connects the second coupling portion 614b and the first coupling portion 614a, so that the main handle 612, the first coupling portion 614a and the second coupling portion 614b jointly encircle an opening 615 for the user's hand holding the main handle 612 to pass through. The second battery pack 642 can be detachably coupled to the second coupling portion 614b along a second direction 600b, and the second direction 600b is also perpendicular to the first axis about which the saw blade 62 rotates. In this example, when the bottom plate plane 651 and the first axis are parallel to each other and the distance between the bottom plate plane 651 and the first axis is the smallest, the first direction 600a intersects with the bottom plate plane 651 to form an included angle greater than or equal to 70 degrees and less than or equal to 90 degrees. The second direction 600b intersects with the bottom plate plane 651 to form an included angle greater than or equal to 0 degrees and less than or equal to 20 degrees, and the first direction 600a and the second direction 600b are also perpendicular to each other, thereby facilitating the user to insert and remove the first battery pack 641 and the second battery pack 642.

The above shows and describes the basic principles, main features and advantages of the present invention. Those skilled in the art should understand that the above-mentioned examples do not limit the present invention in any form, and all technical solutions obtained by equivalent substitutions or equivalent transformations fall within the protection scope of the present invention.

What is claimed is:

1. An electric circular saw, comprising:
a saw blade configured to rotate about a first axis;
a motor comprising a motor shaft for driving the saw blade to rotate;
a housing provided with an accommodating portion for accommodating the motor;
a bottom plate for contacting a workpiece;
a worm gear assembly for realizing power transmission between the motor and the saw blade; and
a power supply device comprising at least one battery pack for providing energy source to the motor;
wherein a ratio of a nominal voltage of one of the at least one battery pack battery pack to a weight of the electric circular saw is greater than or equal to 6V/Kg and less than or equal to 12V/Kg;
wherein the housing comprises:
a main handle comprising a first grip portion for a user to grip; and
a coupling portion for detachably coupling with the at least one battery pack, wherein the coupling portion connects the main handle and the accommodating portion; and
wherein the main handle, the accommodating portion, and the coupling portion are sequentially connected to form an opening through which the user's hand holding the first grip portion passes.

2. The electric circular saw of claim 1, wherein the housing further comprises an auxiliary handle comprising a second grip portion for the user to hold, the first grip portion is symmetrically disposed about a plane, the second grip portion extends in a direction obliquely intersecting the plane, and the direction in which the second grip portion extends obliquely intersects the plane to form an included angle greater than or equal to 50 degrees and less than or equal to 70 degrees.

3. The electric circular saw of claim 1, wherein the power supply device comprises a plurality of battery cells and a ratio of a diameter of the saw blade to a number of the battery cells comprised in the power supply device is greater than or equal to 6 mm/node and less than or equal to 11 mm/node.

4. The electric circular saw of claim 1, wherein a number of the at least one battery pack is 1, a motor axis of rotation of the motor shaft relative to the housing is perpendicular to the first axis, and the at least one battery pack is disposed between the main handle and the motor.

5. The electric circular saw of claim 1, wherein a number of the at least one battery pack is 2, the at least one battery pack are respectively defined as a first battery pack and a second battery pack, the coupling portion is defined as a first coupling portion, the housing is further provided with a second coupling portion for detachably coupling with the second battery pack, and the first coupling portion is provided between the motor and the second coupling portion in a direction of an axis of rotation of the motor shaft.

6. The electric circular saw of claim 5, wherein a direction in which the first battery pack couples to the first coupling portion and a direction in which the second battery pack couples to the second coupling portion are perpendicular to each other.

7. The electric circular saw of claim 1, wherein the bottom plate forms a first plane for contacting the workpiece and, when the first plane and the first axis are parallel to each other, a projection of the at least one battery pack is outside a projection of the bottom plate in the first plane.

8. The electric circular saw of claim 7, wherein one of the at least one battery pack comprise a plurality of battery cells, a battery pack case encircles a battery compartment for accommodating the battery cells, and the battery pack case is provided with a groove into which the coupling portion is embedded when the at least one battery pack couples to the battery pack case.

9. The electric circular saw of claim 1, wherein the nominal voltage of the at least one battery pack is 48V.

10. The electric circular saw of claim 9, wherein one of the at least one battery pack comprises a plurality of battery cell groups connected in series and each battery cell group comprises two battery cells connected in parallel with each other.

11. The electric circular saw of claim 1, wherein the main handle is disposed symmetrically about a plane and a rotation axis of the motor shaft rotates relative to the housing is located in the plane.

12. The electric circular saw of claim 11, wherein when the at least one battery pack couples to the housing and the at least one battery pack is also disposed symmetrically about the plane.

13. The electric circular saw of claim 1, further comprises a circuit board disposed in the accommodating portion, the circuit board and the motor forming an electrical connection, and wherein the housing is provided with an airflow inlet and an airflow outlet and a cooling airflow flows into the housing from the airflow inlet, flows out of the housing from the airflow outlet, and sequentially flows through the circuit board and the motor.

14. The electric circular saw of claim 13, wherein the circuit board comprises a PCB substrate that extends in a plane perpendicular to an axis of rotation about which the motor shaft rotates relative to the housing.

15. The electric circular saw of claim 14, further comprises a heat sink connected to the circuit board, the heat sink comprising a cooling substrate extending in the second plane, and wherein the second plane is perpendicular to the axis of rotation about which the motor shaft rotates relative to the housing.

16. The electric circular saw of claim 15, wherein the heat sink also comprises a sidewall surrounding the cooling substrate at the edge of the cooling substrate, a plurality of cooling ribs are provided on the sidewall, and the plurality of cooling ribs extend in a direction parallel to the axis of rotation about which the motor shaft rotates relative to the housing.

17. The electric circular saw of claim 15, wherein the heat sink also comprises a sidewall surrounding the cooling substrate at the edge of the cooling substrate, a plurality of cooling ribs are provided on the sidewall, an airflow channel for guiding the airflow is provided between two adjacent cooling ribs, the electric circular saw further comprises a wire for connecting the circuit board and the motor; and the wire passes through the airflow channel between the two cooling ribs.

18. The electric circular saw of claim 1, wherein the accommodating portion is made of metal material.

19. The electric circular saw of claim 18, further comprises a circuit board provided in the accommodating portion; a wire connecting the circuit board and the motor, and a limit baffle surrounding a partially open limit space, and wherein the limit baffle restricts the wire within the limit space to prevent the wire from contacting the accommodating portion.

20. An electric circular saw, comprising:
a saw blade configured to rotate about a first axis;
a motor comprising a motor shaft for driving the saw blade to rotate;
a housing provided with an accommodating portion for accommodating the motor;
a bottom plate for contacting a workpiece;
a worm gear assembly for realizing power transmission between the motor and the saw blade; and
a power supply device comprising at least one battery pack for providing energy source to the motor;
wherein a ratio of a nominal voltage of one of the at least one battery pack battery pack to a weight of the electric circular saw is greater than or equal to 6V/Kg and less than or equal to 12V/Kg;
wherein the housing comprises:
a main handle comprising a first grip portion for a user to grip with one hand;
an auxiliary handle comprising a second grip portion for the user to hold with the other hand; and
a coupling portion for detachably coupling with the at least one battery pack; and
wherein a center of gravity of the electric circular saw is located between the first grip portion and the second grip portion.
